(19) United States
(12) Patent Application Publication
(10) Pub. No.: US 2026/0276119 A1
(43) Pub. Date: Sep. 17, 2026

(54) SEAL FOR A TRI-CLAMP CONNECTION, AND TRI-CLAMP CONNECTION HAVING SUCH A SEAL

(71) Applicant: U-CONSULTING GMBH, Wolfertschwenden (DE)

(72) Inventor: Matthias Wagner, Müllheim (DE)

(21) Appl. No.: 19/668,336

(22) Filed: May 5, 2026

Related U.S. Application Data
(62) Division of application No. 19/111,242, filed on Sep. 7, 2023.

(30) Foreign Application Priority Data
Sep. 28, 2022 (DE) 20 2022 105 487.8

(51) Int. Cl. F16L 23/22; F16L 23/04

(52) U.S. Cl. CPC F16L 23/22; F16L 23/04

(57) ABSTRACT

The present invention relates to a seal for a tri-clamp connection, wherein the tri-clamp connection comprises a first flange of a first conduit end and a second flange of a second conduit end, wherein the seal comprises a sealing body that can be placed onto a first end face of the first flange or onto a second end face of the second flange, wherein the sealing body comprises a fastening portion for the form-fitting connection to the first flange or to the second flange.

### SUMMARY

The present invention relates to a seal for a tri-clamp connection, and to a tri-clamp connection having such a seal.

Tri-clamp connections are used to releasably connect a first conduit end to a second conduit end. In this case, the conduit ends to be connected comprise specially shaped tri-clamp flanges, which are interconnected by a tri-clamp bracket. The tri-clamp flanges are also referred to as tri-clamp couplings, which are in particular constructed as standard tri-clamp couplings. Standard tri-clamp couplings are standardized in ISO 2852 1993-06 (published in June 1993, since withdrawn) or in DIN 32676 in the version valid on the priority date, for example. The standard tri-clamp couplings are frequently used in biotechnological and pharmaceutical applications in particular.

To make it possible to sealingly interconnect the conduit ends using the tri-clamp connections, seals are used which are arranged between a first end face of the first tri-clamp flange and a second end face of the second tri-clamp flange. In this process, the tri-clamp bracket moves the first tri-clamp flange and the second tri-clamp flange toward one another, as a result of which the seal is compressed and can consequently take its sealing effect. However, a reliable sealing effect can only be obtained if the seal is accurately positioned in relation to the first end face and the second end face.

Depending on the application, the first conduit end is only connected to the second conduit end for a short time, for example when a reactor is to be filled with a starting material that is converted into product material in the reactor. The tri-clamp connection is closed and opened again accordingly frequently. The first conduit end is frequently rigidly connected to the reactor and oriented such that closing and opening it requires a certain degree of dexterity on the part of the operator in question. When closing the tri-clamp connection, the operator needs both hands, and therefore it is not possible to correct the position of the seal here, if this is needed. As mentioned, the seal can be incorrectly positioned and consequently leaks can occur. If an operator notices the incorrect positioning, the closing process has to be repeated, which means that time is lost.

The problem addressed by one embodiment of the present invention is therefore to propose a seal for a tri-clamp connection by means of which it is possible to remedy the above-mentioned drawbacks in a simple and cost-effective manner. In particular, a seal for tri-clamp connection is to be provided which can be arranged in the correct position relative to the first tri-clamp flange or relative to the second tri-clamp flange in a simple manner, and this position is maintained in particular while closing the tri-clamp connection.

This problem is solved by the features specified in claims 1 and 4. Advantageous embodiments are found in the dependent claims.

One embodiment of the invention relates to a seal for a tri-clamp connection, wherein the tri-clamp connection comprises a first flange of a first conduit end and a second flange of a second conduit end, comprising
a sealing body that can be placed onto a first end face of the first flange or onto a second end face of the second flange, wherein
the sealing body comprises a fastening portion for the form-fitting connection to the first flange or to the second flange.

It is proposed that the sealing body comprises a fastening portion, by means of which the seal can be form-fittingly connected to the first flange or the second flange before the first conduit end and the second conduit end are interconnected to form a tri-clamp connection. The form-fitting connection can be designed in the manner of a snap-in or clip-in connection. In this case, the sealing body and in particular the connecting portion are made of a material which is elastically deformable in order to provide the form-fitting connection and release it again. For this purpose, the sealing body can consist of or comprise an elastomer.

Owing to the option of being able to form-fittingly connect the sealing body to the first flange or the second flange, the sealing body maintains the position in relation to the first flange or to the second flange once the form-fitting connection is completed. In this case, the seal is designed such that the sealing body is in the desired position when the form-fitting connection is completed. This makes it considerably easier for the operator to close the tri-clamp connection, speeds up the process and avoids incorrect positioning.

According to another embodiment, the fastening portion can comprise a projection which, for the form-fitting connection,
engages in a first recess in the first flange or in a second recess in the second flange, or or
engages behind the first flange or the second flange.

Providing a recess is a comparatively simple manufacturing process, such that the form-fitting connection can be provided without significant additional effort. In this case, it makes sense to provide the recess on a circumferential surface of the first flange or the second flange. Alternatively, a projection, which engages in a recess in the fastening portion, can be provided on the above-mentioned circumferential surface.

If said projection engages behind the first flange or the second flange, the first recess and/or the second recess can be omitted.

In a developed embodiment, the sealing body can comprise
a first sealing projection, which engages in a first seal recess arranged on the first end face when the sealing body is form-fittingly connected to the first flange, and/or
a second sealing projection, which engages in a second seal recess arranged on the second end face when the sealing body is form-fittingly connected to the second flange.

The first sealing projection and the first seal recess or the second sealing projection and the second seal recess both increase the sealing effect of the seal, since this increases the sealing surface area, and also contribute to the correct positioning of the seal.

One configuration of the invention relates to a tri-clamp connection comprising a first flange of a first conduit end and a second flange of a second conduit end, wherein the tri-clamp connection is sealed by means of a seal according to any of the embodiments discussed above.

The technical effects and advantages that can be achieved by the proposed tri-clamp connection correspond to those that have been discussed for the present seal. In summary, it should be noted that it is possible, using comparatively simple means, to arrange the seal in the desired position in relation to the first flange or to the second flange, wherein the desired position is maintained in particular when closing the tri-clamp connection. This makes it easier to close the tri-clamp connection, speeds up the process and reduces the probability of incorrect positioning and resulting leaks.

In another configuration, it can be provided that the first flange comprises a first recess and/or the second flange comprises a second recess, wherein the projection of the fastening portion form-fittingly engages in the first recess or in the second recess.

Providing a recess is a comparatively simple manufacturing process, such that the form-fitting connection can be provided without significant additional effort. In this case, it makes sense to provide the recess on a circumferential surface of the first flange or the second flange. Alternatively, a projection, which engages in a recess in the fastening portion, can be provided on the above-mentioned circumferential surface.

An exemplary embodiment of the invention is described in greater detail in the following with reference to the accompanying drawings, in which:

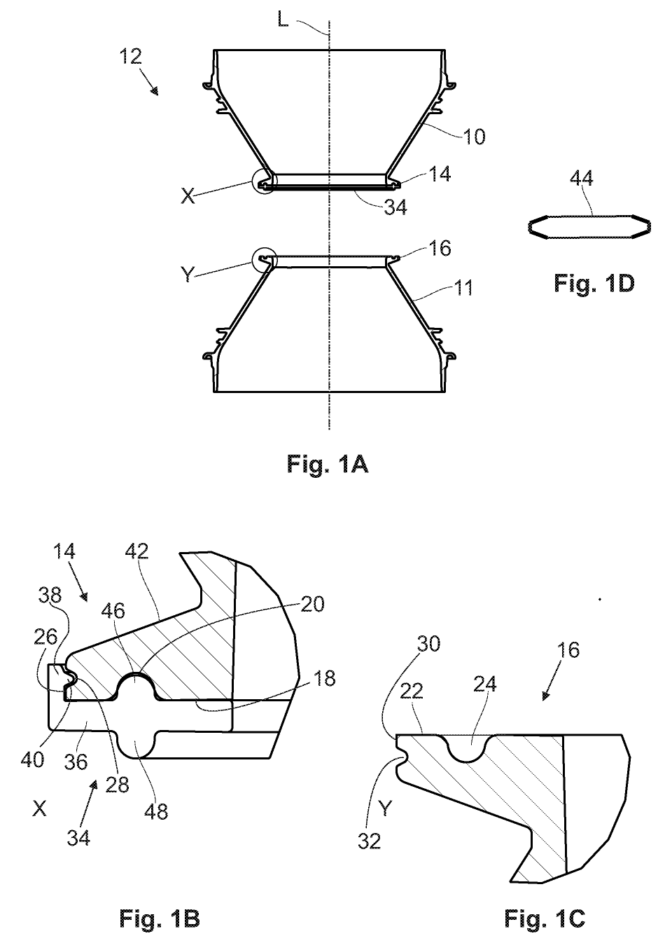

FIG. 1A shows a first conduit end and a second conduit end, which can be interconnected to form a proposed tri-clamp connection,

FIG. 1B is an enlarged view of the detail X defined in FIG. 1A,

FIG. 1C is an enlarged view of the detail Y defined in FIG. 1A, and

FIG. 1D is a schematic view of a tri-clamp bracket for forming a tri-clamp connection.

FIG. 1 shows a first conduit end 10 and a second conduit end 11, which are to be interconnected to form a tri-clamp connection 12. In this case, the first conduit end 10 comprises a first flange 14 and the second conduit end 11 comprises a second flange 16, which are formed in the manner of a tri-clamp flange or tri-clamp coupling. In this case, the first flange 14 forms a first end face 18 comprising a first seal recess 20 (see FIG. 1B) and the second flange 16 forms a second end face 22 comprising a second seal recess 24 (see FIG. 1C). In addition, the first flange 14 comprises a first circumferential surface 26, on which a first recess 28 is arranged. Accordingly, the second flange 16 comprises a second circumferential surface 30, on which a second recess 32 is arranged.

In addition, a seal 34 is arranged on the first end face 18 (see FIG. 1A and 1B). The seal 34 comprises a sealing body 36 comprising a fastening portion 38. The fastening portion 38 extends substantially in parallel with the first circumferential surface 26 and surrounds it when the seal 34 is arranged on the first end face 18. The fastening portion 38 forms a projection 40, which points toward a longitudinal axis L (see FIG. 1A) defined by the first conduit end 10. When the seal 34 is arranged on the first end face 18, the projection 40 engages in the first recess 28 and consequently form-fittingly connects the seal 34 to the first flange 14 of the first conduit end 10. The seal 34 is positioned in relation to the first conduit end 10 as intended and no longer changes its position.

For the form-fitting connection to the first conduit end 10, the seal 34 is first positioned concentrically with the longitudinal axis L and is then moved toward the first flange 14 along the longitudinal axis L. In this case, when the projection 40 is contacted by the first flange 14, the fastening portion 38 is first moved slightly radially outward until the projection 40 can engage in the first recess 28. In this case, the fastening portion 38 moves back into its original position again, as a result of which the form-fitting connection is provided.

As shown in FIG. 1A and 1B, the first end face 18 of the first conduit end 10 points downward. Nevertheless, the seal 34 can be connected to the first conduit end 10 without it falling out.

The seal 34 can also be connected to the second flange 16 of the second conduit end 11 in a similar manner. Since the fastening portion 38 comprises just one projection 40, however, it has to be decided whether the seal 34 is to be first connected to the first flange 14 of the first conduit end 10 or to the second flange 16 of the second conduit end 11 before the tri-clamp connection 12 is formed. This means that it is not necessary to provide both the first flange 14 comprising the first recess 28 and the second flange 16 comprising the second recess 32. One of the two recesses 28, 32 is sufficient.

Furthermore, it is shown in particular in FIG. 1B that the sealing body 36 comprises a first sealing projection 46 which projects into the first seal recess 20 that has already been mentioned. The sealing body 36 also comprises a second sealing projection 48, which engages in the seal recess 24 in the second flange 16 (see FIG. 1C) when the tri-clamp connection 12 is formed.

An embodiment in which the fastening portion 38 engages behind the first flange 14, for example, is not shown. For this purpose, the projection 40 can be arranged at the free end of the fastening portion 38 and can come to rest on a first sloping face 42 of the first flange 14 when the seal 34 is arranged on the first end face 18.

To close the tri-clamp connection 12, the second conduit end 11 is first positioned concentrically with the longitudinal axis L and is then moved along the longitudinal axis L toward the first conduit end 10 until the second end face 22 comes into contact with the seal 34. The second sealing projection 48 then engages in the second seal recess 24 (not shown). A tri-clamp bracket 44 shown in FIG. 1D is then placed around the first flange 14 and the second flange 16 and is tightened by a closure device (not shown), which can comprise a screw connection. Consequently, the tri-clamp bracket 44 moves radially inward at least in portions, which results in an axial relative movement of the first conduit end 10 and the second conduit end toward one another. The seal 34 is therefore compressed and takes its sealing effect.

To release the tri-clamp connection 12, the process is carried out in the reverse order.

### LIST OF REFERENCE SIGNS

10 First conduit end

11 Second conduit end

12 Tri-clamp connection

14 First flange

16 Second flange

18 First end face

20 First seal recess

22 Second end face

24 Second seal recess

26 First circumferential surface

28 First recess

30 Second circumferential surface

32 Second recess

34 Seal

36 Sealing body

38 Fastening portion

40 Projection

42 First sloping face

44 Tri-clamp bracket

46 First sealing projection

48 Second sealing projection

L Longitudinal axis

1. A method, comprising:
providing a biotechnological or pharmaceutical seal for a biotechnological or pharmaceutical tri-clamp connection, wherein the biotechnological or pharmaceutical tri-clamp connection includes a first flange of a first conduit end with a first sloping face and a second flange of a second conduit end with a second sloping face, and a biotechnological or pharmaceutical tri-clamp bracket;
placing a biotechnological or pharmaceutical sealing body onto a first end face of the first flange or onto a second end face of the second flange;
wherein the biotechnological or pharmaceutical sealing body includes a fastening portion for a form-fitting connection to the first flange or to the second flange, the fastening portion including a projection for the form-fitting connection; and
engaging the projection in a first recess disposed at a first circumferential surface of the first flange or in a second recess disposed at a second circumferential surface of the second flange.

2. The method according to claim 1, further comprising:
engaging a first sealing projection of the biotechnological or pharmaceutical sealing body in a first seal recess disposed at the first end face when the biotechnological or pharmaceutical sealing body is form-fittingly connected to the first flange; or
engaging a second sealing projection of the biotechnological or pharmaceutical sealing body in a second seal recess disposed at the second end face when the biotechnological or pharmaceutical sealing body is form-fittingly connected to the second flange.

3. The method according to claim 1, further comprising:
when the projection is contacted by the first flange, the fastening portion is first moved radially outward until the projection engages in the first recess, and then the fastening portion moves back radially inward into an original position again based on the form-fitting connection being provided.

4. The method according to claim 1, further comprising:
the projection being arranged at a free end of the fastening portion and coming to rest on the first sloping face of the first flange when the biotechnological or pharmaceutical seal is arranged on the first end face.

5. The method according to claim 2, further comprising closing the tri-clamp connection by:
first positioning the second conduit end concentrically with the second conduit end and then moving the second conduit end toward the first conduit end until the second end face comes into contact with the biotechnological or pharmaceutical seal; and
engaging the second sealing projection in the second seal recess.

6. The method according to claim 5, further comprising:
placing the biotechnological or pharmaceutical tri-clamp bracket around the first flange and the second flange and tightening the biotechnological or pharmaceutical tri-clamp bracket, which moves the biotechnological or pharmaceutical tri-clamp bracket inward at least in portions.

7. The method according to claim 6, further comprising:
based on the biotechnological or pharmaceutical tri-clamp bracket moving radially inward at least in portions, moving the first conduit end and the second conduit end toward one another, thereby compressing and sealing the biotechnological or pharmaceutical seal and providing the form-fitting connection.
